(19) United States
(12) Patent Application Publication
(10) Pub. No.: US 2019/0088030 A1
(43) Pub. Date: Mar. 21, 2019

(54) RENDERING VIRTUAL OBJECTS BASED ON LOCATION DATA AND IMAGE DATA

(71) Applicant: Microsoft Technology Licensing, LLC, Redmond, WA (US)

(72) Inventors: Clark MASTERSON, Sammamish, WA (US); Felix G.T.I. ANDREW, Seattle, WA (US); Joao Celestino Leite Pinheiro de Paiva, Issaquah, WA (US); Silvana P. MONCAYO, Seattle, WA (US)

(21) Appl. No.: 15/710,575

(22) Filed: Sep. 20, 2017

(51) Int. Cl. G06T 19/20; G06T 19/00; G01S 19/01; G06F 3/01

(52) U.S. Cl. CPC G06T 19/20; G06F 3/011; G01S 19/01; G06T 19/006

(57) ABSTRACT

Location data and image data are captured at a location. The location data may include GPS coordinates and the image data may include images or videos taken at the location. The image data is processed to identify anchor points associated with the location. The location data and the anchor points are provided to a cloud service that uses the location data and image data to create a map of locations and anchor points. A user can associate a virtual object with one or more anchor points associated with a location. At a later time, when the same or different user visits the location, the virtual object may be displayed to the user in an AR application at anchor points that match the one or more anchor points associated with the location.

### BACKGROUND

Virtual reality (VR) and Augmented Reality (AR) have become popular applications on modern smartphones and other devices. In VR applications, a user wears goggles or a headset that immerses the user in a computer generated virtual environment. The virtual environment may be a completely new or fictitious environment, or may be based on a real location.

In AR applications, the user views the real world through glasses, goggles, or the camera of their smartphone, and one or more virtual elements are projected or rendered into the user's field of view. For example, a user may wear a headset while using a map application. As the user sees the real world through the headset, the map application may project directional elements such as arrows into the field of view of the user so that the directional elements appear to part of the real world. In another example, a user may use the camera of their smartphone as part of a “ghost hunting” videogame application, where rendered ghosts appear to be near the user when the user views their environment through their smartphone camera.

While such VR and AR applications are becoming more popular as the processing capabilities of smartphones and other devices increase, there are some drawbacks associated with the applications. For AR applications, there is no easy way to share AR experiences with other users. Typically, when a user views their surroundings, the AR application uses image processing techniques to create a model of the environment that the user can then interact with through the AR application. For example, the user can place virtual objects in the environment such as signs or posters. The user can then interact with the virtual objects, and can even visit the virtual objects again when the user returns to the environment. However, there is no way for the user to share a virtual object and its placement in the environment with other users, so that the other users can travel to the same environment and interact with the shared virtual object in an AR or VR application.

### SUMMARY

Location data and image data are captured at a location. The location data may include GPS coordinates and the image data may include images or videos taken at the location. The image data is processed to identify anchor points associated with the location. The location data and the anchor points are provided to a cloud service that uses the location data and image data to create a map of locations and anchor points. A user can associate a virtual object with one or more anchor points associated with a location. Later, when the same or a different user visits the location, the virtual object may be displayed to the user in an AR application or VR application at anchor points that match the one or more anchor points associated with the location.

In an implementation, a system for capturing image data for locations, determining anchor points in the captured image data for the locations, and for sharing the determined anchor points and captured image data for use in augmented reality and virtual reality applications is provided. The system includes: at least one computing device, and a mapping engine that: determines location data associated with a location of a plurality of locations; captures image data associated with the location; renders an environment based on the captured image data; processes the captured image data to determine a plurality of anchor points for the location; and provides the plurality of anchor points and the location data for the location.

In an implementation, a method for receiving image data for locations, determining anchor points in the received image data for the locations, receiving virtual objects associated with the locations, and storing the received virtual objects for use in augmented reality and virtual reality applications is provided. The method may include: receiving location data associated with a location of a plurality of locations by a computing device; receiving image data associated with the location by the computing device; processing the image data to determine a plurality of anchor points for the location by the computing device; providing the plurality of anchor points by the computing device; receiving a virtual object by the computing device, wherein the virtual object is associated with a subset of the plurality of anchor points; and storing the virtual object and the plurality of anchor points with the location data by the computing device.

In an implementation, a system for capturing image data for locations, rendering environments based on the captured image data, and for rendering received virtual objects in the rendered environments for use in augmented reality and virtual reality applications is provided. The system includes at least one computing device, and a mapping engine that: determines location data associated with a location of a plurality of locations; captures image data associated with the location; renders an environment based on the captured image data; processes the captured image data to determine a plurality of anchor points for the location; receives a first virtual object associated with a first subset of the plurality of anchor points; locates the first subset of the plurality of anchor points in the plurality of anchor points; and in response to locating the first subset of the plurality of anchor points, renders the received first virtual object in the rendered environment based on the first subset of the plurality of anchor points.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for capturing image data and location data, determining anchor points in the captured image data, and for sharing the location data and determined anchor points for use in AR and VR applications;

FIG. 2 is an illustration of an implementation of an exemplary mapping engine 165;

FIGS. 3-9 are illustrations of an example user interface for placing and viewing virtual objects in an AR application;

FIG. 10 is an operational flow of an implementation of a method for collecting image data, determining anchor points in the collected image data, and for associating a virtual object with a subset of the determined anchor points;

FIG. 11 is an operational flow of an implementation of a method for receiving image data, determining anchor points in the received image data, receiving a virtual object, and for providing the virtual object to a selected user;

FIG. 12 is an operational flow of an implementation of a method for capturing image data for a location, rendering an environment based on the captured image data, receiving a virtual object, and rendering the received virtual object in the environment; and

FIG. 13 shows an exemplary computing environment in which example embodiments and aspects may be implemented.

### DETAILED DESCRIPTION

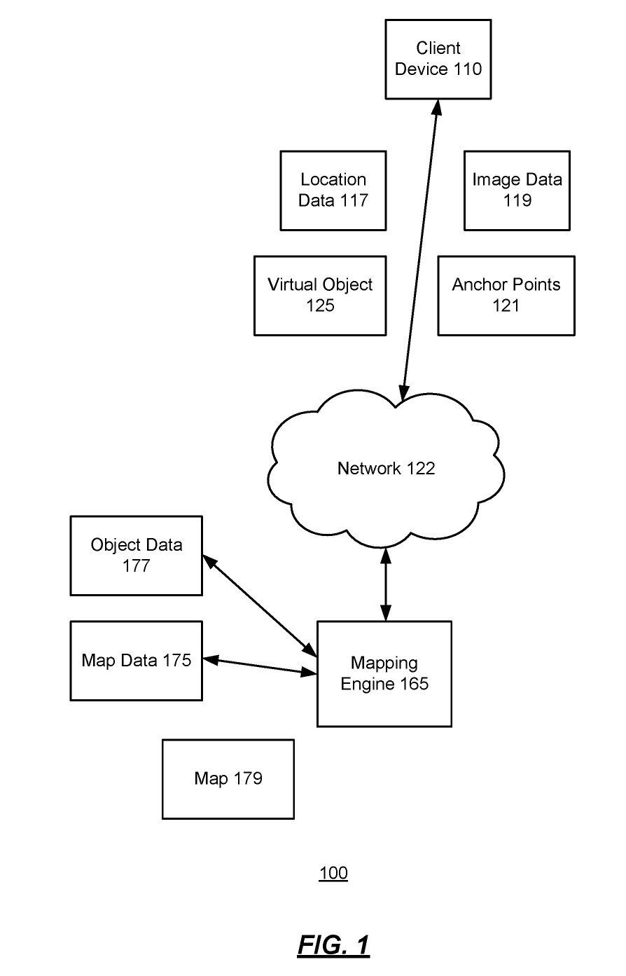

FIG. 1 is an illustration of an exemplary environment for capturing image data and location data, determining anchor points in the captured image data, and for sharing the location data and determined anchor points for use in Augmented Reality (AR) and Virtual Reality (VR) applications. The environment 100 may include a mapping engine 165, and one or more client devices 110 in communication through a network 122. The network 122 may be a variety of network types including the public switched telephone network (PSTN), a cellular telephone network, and a packet switched network (e.g., the Internet). Although only one client device 110 and one mapping engine 165 are shown in FIG. 1, there is no limit to the number of client devices 110 and mapping engines 165 that may be supported.

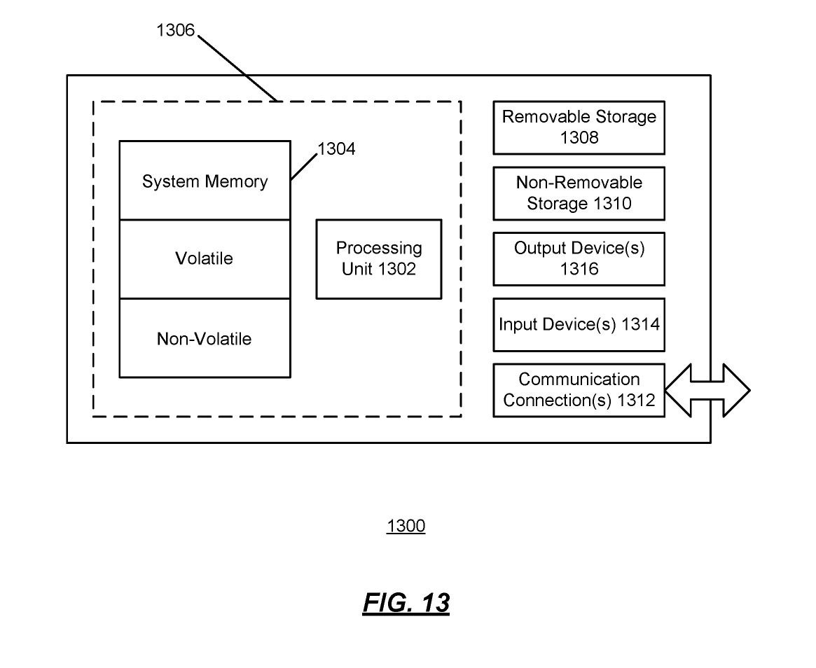

The client device 110 and the mapping engine 165 may be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 13 as the computing device 1300.

In some implementations, the client device 110 may be a computing device that is suited to provide one or more AR applications. Example computing devices include a headset that allows light to pass through the headset such that a user can view their environment as if they were looking through conventional glasses, but that is configured to render virtual objects such that they appear to the user as if they are part of their environment. Another example computing device is a smartphone that can capture images or videos of a user's environment, and can render virtual objects into the captured images or videos as they are viewed by the user on a display associated with the smartphone.

In other implementations, the client device 110 may be a computing device that is suited to provide one or more VR applications. Example computing devices include a headset that presents a virtual environment to the user including virtual objects, while mostly blocking out any light from the “real world.” The headset may use one or more smartphones to control the headset, or to provide the virtual environment.

The client device 110 may be configured to collect location data 117 and image data 119 at a location. The location data 117 may be any data that can be used to locate the client device 110 or that indicates the location of the client device 110. One example of location data 117 is geographic coordinates. The geographic coordinates may be GPS coordinates and may be collected from a GPS component of the client device 110.

Another example of location data 117 may be altitude measurements or elevation measurements. As may be appreciated, for indoor environments such as buildings, the GPS coordinates cannot indicate what floor or level the client device 110 is located at. Accordingly, the location data 117 may include data such as altitude measurements or elevation measurements that can be used to determine what level or floor the client device 110 is located on. Depending on the implementation, the altitude measurements or elevation measurements may be collected from one or more sensors associated with the client device 110. Other types of measurements such as orientation measurements may also be used.

In some implementations, the location data 117 may be based on signals from one or more beacons. For example, an office building may have one or more beacons that provide a wireless signal that may be used to determine what room the client device 110 is located in. In another example, the strength of signals received from one or more Wi-Fi routers, access points, or cell phone towers having known locations may be used to determine the location of the client device 110 in the building. Other types of beacons may be supported.

The image data 119 may include images or videos captured by the client device 110. Depending on the implementation, the image data 119 may be captured by one or more cameras associated with the client device 110. The image data 119 may include visible light as well as non-visible light such as infrared and ultraviolet light, for example.

In some implementations, the client device 110 (and/or the mapping engine 165) may render some or all of the image data 119 to create an environment that is viewed by the user associated with the client device 110. For example, an AR application executing on the client device 110 may display an environment based on the image data 119 captured by the camera associated with the client device 110. In implementations where the client device 110 is a headset or goggles that allow the light to reach the eyes of the user, the environment may be formed by the light that reaches the eyes of the user wearing the client device 110.

The client device 110 (and/or the mapping engine 165) may process the image data 119 to determine one or more anchor points 121. An anchor point 121 may be a point or an area of the image data 119 that is visually interesting and therefore can be readily matched and compared with other anchor points 121. Examples of anchor points 121 may include areas of an image where planes interact such as corners, or areas of an image where colors, contrasts, or materials interact or change such as a rug on a floor, or a poster on a wall. Any method or technique for determining anchor points 121 in an image or video may be used.

The client device 110 may allow a user to place a virtual object 125 in the environment represented by the image data 119. A virtual object 125 may be a graphic or a visual presentation of an object. The virtual object 125 may have properties such as size, mass, shape, color, etc., that indicate how the virtual object 125 will be rendered in the environment and how the user (or other users) may interact with the virtual object 125.

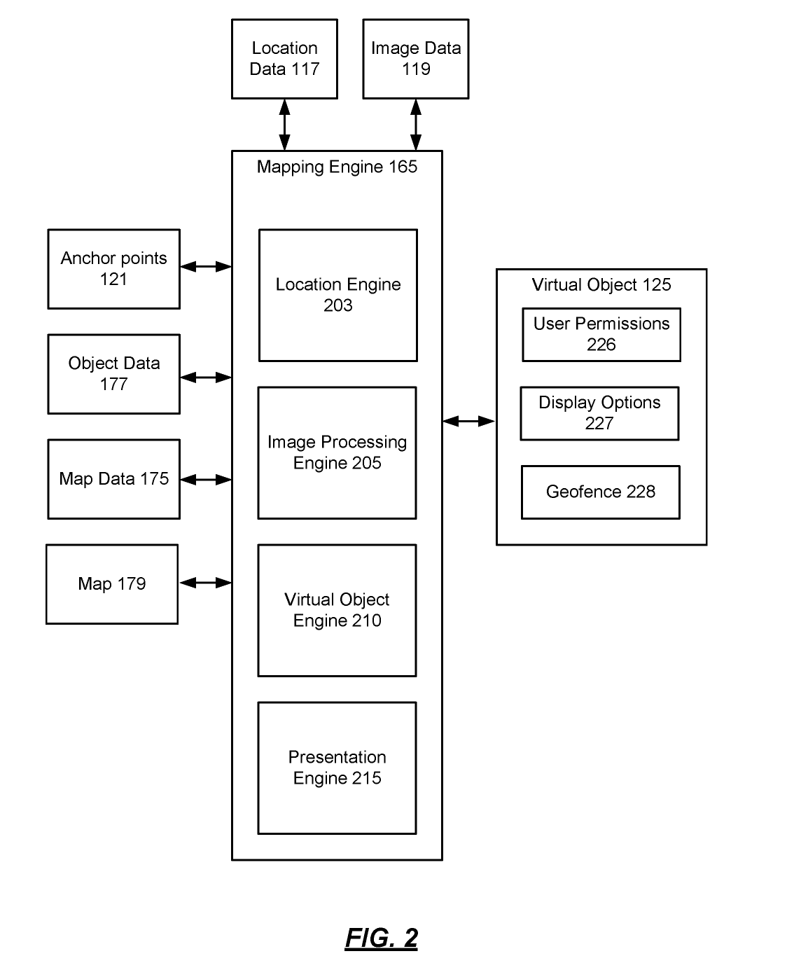

The client device 110 may associate the virtual object 125 with one or more anchor points 121 from the image data 119. For example, a user may place a virtual object 125 such as a duck on the floor of room using the client device 110. In response, the client device 110 may associate the virtual object 125 with one or more of the anchor points 121. The associated anchor points 121 may be the closest anchor points 121 and may include other information such the distances between each associated anchor point 121 and the virtual object 125. As described with respect to FIG. 2, other information may be associated with the virtual object 125.

The client device 110 may provide the location data 117, anchor points 121, and some or all of the image data 119 to the mapping engine 165. The mapping engine 165 may store the location data 117, anchor points 121, and image data 119 as part of the map data 175. As may be appreciated, the map data 175 may be used to generate a map 179 that combines some or all of the location data 117, image data 119, and anchor points 121 that have been provided by the users of the mapping engine 165.

Where the user placed a virtual object 125, the client device 110 may also provide the virtual object 125 to the mapping engine 165 and may indicate which anchor points 121 are associated with the virtual object 125. The mapping engine 165 may store the received virtual objects 125 and associated anchor points 121 as the object data 177.

The generated maps 179 and object data 177 can be used in one or more AR applications to place virtual objects 125, and to determine what virtual objects 125 have been placed near or around a current location associated with a client device 110. In addition, the map data 175 and object data 177 can be used by one or more VR applications. For example, a VR user may use a client device 110 to select locations and interact with one or more virtual objects 125 based on the image data 119 and anchor points 121 associated with the location data 117 corresponding to the selected locations.

FIG. 2 is an illustration of an implementation of an exemplary mapping engine 165. The mapping engine 165 may include one or more components including a location engine 203, an image processing engine 205, a virtual object engine 210, and a presentation engine 215. More or fewer components may be included in the mapping engine 165. Some or all of the components of the mapping engine 165 may be implemented by one or more computing devices such as the computing device 1300 described with respect to FIG. 13. In addition, some or all of the functionality attributed to the mapping engine 165 may be performed by the client device 110, or some combination of the client device 110 and the mapping engine 165.

The location engine 203 may collect location data 117 based on a current location of a client device 110. The location data 117 may include GPS coordinates associated with the client device 110, and altitude or elevation measurements associated with the client device 110. Other information such as Wi-Fi signals and signal strength, and information received from one or more beacons may be also be collected as part of the location data 117.

The location engine 203 may use the collected location data 117 to determine the current location of the client device 110. Where the location of the client device 110 is outdoors, the location engine 203 may use the GPS coordinates from the location data 117. For indoor locations, such as buildings, the location engine 203 may use the location data 117 to more specifically determine the floor and/or room where the client device 110 is located. Depending on the implementation, the location engine 203 may have access to blueprints or other information about the layout of the indoor location that can be combined with the location data 117 to determine the location of the client device 110.

For example, the location data 117 may indicate that a client device 110 is located on an east side of a building. Using the information about the height of the building, the height of each floor, and the altitude of the client device 110, the location engine 203 may determine the room and/or floor number of the building where the client device 110 is located. Other information such as beacon and Wi-Fi signals included in the location data 117 may be used to determine the room and/or floor of the building where the client device 110 is located.

The image processing engine 205 may collect image data 119 associated with a determined location. The image data 119 may include images and/or videos that are collected by the client device 110. In some implementations, an AR application executing on the client device 110 may instruct the user associated with the client device 110 to move around the location so that images and videos of the location can be captured from a variety of angles and perspectives. The image data 110 may capture spatial data about the environment associated with the location.

The image processing engine 205 may process the collected image data 119 to generate a 3D model or representation of the environment around the location of the client device 110. The 3D model may encompass all of the spatial data about the environment captured in the image data 119 and may include various visible surfaces of the environment such as walls, floors (or ground), and the ceiling. The 3D model may also capture any objects that are visible in the environment such as furniture, rugs, trees, paintings, rocks, hills, etc. The 3D model may further capture any 3D landmarks that are captured in the image data 119. Any method for generating a 3D model from image data 119 may be used. For example, the 3D model may be generated from the image data 119 using a variety of techniques for 3D reconstruction from multiple images including triangulation, autocalibration, and stratification. Other techniques may be used.

The generated 3D model may further include one or more anchor points 121. The anchor points 121 may be points of the 3D model that represent points or areas of visual interest in the environment. For example, there may be anchor points 121 where different surfaces intersect in the 3D model (e.g., corners), where colors or materials change in the 3D model (e.g., a rug on a floor, or a painting on a wall), or where objects are placed in the environment. Any method for selecting anchor points 121 may be used.

The image processing engine 205 may store the anchor points 121, and the determined location, in the map data 175. Depending on the implementation, the image processing engine 205 may further store the image data 119 with the anchor points 121 and the determined location or location data 117.

The imaging processing engine 205 may use the map data 175 to generate a map 179. The map 179 may be generated by associating the anchor points 121 (and/or image data 119 and 3D model) for each location with a corresponding location on the map 179. Depending on the implementation, the map 179 may be constructed using map data 175 received from multiple users of the mapping engine 165 (i.e., crowdsourced), or each user may be associated with their own map 179. The map 179 may be a representation of the physical world that is generated from the map data 179 (e.g., the image data 119 and the location data 117).

As may be appreciated, the image data 119, location data 117, and map data 175 collected and stored by the mapping engine 165 for each user may be personal and private. Accordingly, to protect the privacy of each user, any data collected by the mapping engine 165 may be encrypted. Moreover, before any data is collected and used by the mapping engine 165, each user may be asked to opt-in or otherwise consent to the collection and use of such data.

The virtual object engine 210 may allow a user to create and place virtual objects 125 at one or more locations. A virtual object 125 may be a graphical representation of an object that can be rendered by the mapping engine 165 at a location. Depending on the implementation, a virtual object 125 may be animated or may be static. A virtual object 125 may also have audio or video properties. For example, a virtual object 125 of a duck may play quacking sounds when viewed by a user, or may show a video of duck cartoon when approached by a user.

A user may create a virtual object 125 by selecting a virtual object 125 from a list of virtual objects 125 that are provided by the virtual object engine 210. For example, the virtual object engine 210 may make a library of virtual objects 125 available for the user to select from. Alternatively, the users may create their own virtual objects 125. For example, the virtual object engine 210 may make one or more tools available through which users may create or modify virtual objects 125.

After a user creates and/or selects a virtual object 125, the user may place the virtual object 125 in an environment. In some implementations, the user may use an AR application to view the environment at a location and the image processing engine 205 may determine anchor points 121 for the location based on captured image data 119. After the anchor points 121 have been determined, the user may use the AR application to “place” the virtual object 125 in the environment as rendered and displayed to the user through the AR application.

For example, a user of an AR application may use the AR application to place a virtual object 125 on a table in a room corresponding to a location. The AR application may then render and display the virtual object 125 to the user on the table so that the virtual object 125 appears to be located on the table.

After the virtual object 125 has been placed in the environment, the virtual object engine 210 may determine one or more anchor points 121 of the anchor points 121 associated with the location to associate with the virtual object 125. The determined anchor points 121 may be the closest anchor points 121 to the virtual object 125. Any method for selecting anchor points 121 may be used.

The virtual object engine 210 may store the determined anchor points 121 with the virtual object 125 in the object data 177. The virtual object 125 may further be associated with the location corresponding to the determined anchor points 121.

Other information may be associated with the virtual object 125 by the virtual object engine 210. In some implementations, the virtual object 125 may be associated with one or more of user permissions 226, display options 227, and geofences 228. The user permissions 226 may control what users may view or interact with the virtual object 125. For example, a user who creates a virtual object 125 may specify in the user permissions 226 that the virtual object 125 may be viewed by all users, only users who are “friends” or contacts in one or more social networking applications, or only specific users.

The display options 227 may control how the virtual object 125 is rendered or appears in one or more VR or AR applications. In some implementations, the display options 227 may specify how the virtual object 125 appears at certain angles or from certain distances. For example, a user may specify that the virtual object 125 is only visible to users who view the virtual object 125 while facing a certain direction. In another example, the user may specify that the virtual object 125 looks a certain way when viewed from a distance that is greater than a specified distance, and looks a different way when viewed from a distance that is less than the specified distance.

The geofence 228 may be a boundary or virtual fence outside of which the virtual object 125 may not be visible, or that may change how the virtual object is displayed or rendered based on whether or not the user is inside or outside of the geofence 228. An example of a geofence 228 is a shape such as a circle on the map 179. Locations on the map 179 that are within the shape are inside the geofence 228, and locations that are outside the shape are outside the geofence 228.

Depending on the implementation, the virtual object engine 210 may provide a tool that a user may user to create a geofence 228. For example, the user may provide a radius and center for the geofence 228, or the user may “draw” a geofence 228 on the map 179 around a particular location.

As may be appreciated, the user permissions 226, display options 227 and geofences 228 may be combined by the user to customize how and when a virtual object 125 is displayed to other users. A user may specify different display options 227 for a virtual object 125 depending on the locations of other users with respect to one or more geofences 228 or based on the user permissions 226. For example, a user may specify that a virtual object 125 is displayed for most users only when the users are within a geofence 228, and that the virtual object 125 is always displayed for users that they are connected to in a social networking application regardless of their position with respect to the geofence 228.

The presentation engine 215 may present virtual objects 125 for rendering in environments. In some implementations, when a user of a client device 110 executes an AR application, the AR application may periodically provide location data 117 to the presentation engine 215. The location data 117 may include the current location of the client device 110, and any locations that may be visible in the environment that the user is interacting with in the AR application. For a VR application, the VR application may similarly provide location data 117 corresponding to the purported location that the user is exploring virtually using the VR application.

Based on the location data 117, the presentation engine 215 may determine one or more virtual objects 125 that are associated with the location of the client device 110 and/or any locations that are visible to the user at the client device 110. The presentation engine 215 may provide the virtual objects 125 and the associated anchor points 121.

The client device 110 and/or the presentation engine 215 may, for some or all of the received virtual objects 125, process the image data 119 associated with the environment of the AR application or VR applications to locate or match some of the anchor points 121 associated with the received virtual objects 125. The client device 110 and/or the presentation engine 215 may place or render one or more of the virtual objects 125 based on the anchor points 121 located in the environment. The client device 110 and/or the presentation engine 215 may place or render the virtual objects 125 according to one or more of the user permissions 226, display options 227, and geofences 228 associated with the virtual objects 125, if any.

As may be appreciated, the mapping engine 165 may provide for a variety of implementations in both VR and AR applications. One such implementation is the sharing of virtual objects 125 with other users. For example, a first user may desire to share a virtual object 125 with a second user. The first user may use an AR application on a client device 110 such as a smartphone. The first user may view the space in front of them using the viewfinder of their smartphone and may use the virtual object engine 210 to select a virtual object 125, and to place the virtual object 125 in the environment that they are viewing. In response, the image processing engine 205 may collect and process image data 119 of the viewing environment to determine anchor points 121 to associate with the virtual object 125. Depending on the implementation, the client device 110 may prompt the first user to walk around the environment so that additional anchor points 121 and/or perspectives of the virtual object 125 may be captured. The first user may also provide a radius for a geofence 228 around the virtual object 125. The virtual object 125, anchor points 121, and geofence 228 may be provided by the AR application to the mapping engine 165.

The first user may send a message to the second user using a messaging application that includes the virtual object 125. The messaging application may provide the virtual object 125 to a corresponding AR application on the second user's smartphone or headset, and the second user may be notified that the virtual object 125 has been provided. When the second user later enters the geofence 228 associated with the virtual object 125, the virtual object 125 may be rendered and displayed by the AR application at the anchor points 121 associated with the virtual object 125. For VR applications, the virtual object 125 may similarly be displayed by the VR application when the second user enters the geofence 228 in a corresponding VR environment.

As an additional feature to the implementation described above, the first user may desire to ensure that the virtual object 125 is viewed from a specific angle or viewpoint. For example, the virtual object 125 may be a virtual billboard, a note, a virtual message, or other piece of content that is most impactful when viewed from a specific angle.

Accordingly, the first user may provide display options 227 for the virtual object 125 that have the virtual object 125 rendered as a blur or abstraction for the second user when the second user views the virtual object 125 from angles outside of a specified angle range, and have the virtual object 125 correctly rendered when the second user views the virtual object 125 from angles within the specified angle range.

In another implementation, the mapping engine 165 may allow users of VR and AR applications to share or view virtual objects 125 that are at locations that are different than their current location. For example, a first user may desire to share a virtual object 125 with a second user at a location that is different than a current location of the first user. Accordingly, the first user may use the map 179 of locations that have associated anchor points 121 to select a location. The AR or VR application associated with the user may retrieve the anchor points 121 associated with the location, and may render an environment for the first user using the anchor points 121. The first user may place the virtual object 125 in the rendered environment, and the virtual object engine 210 may associated the placed virtual object 125 with one or more of the anchor points 121. The virtual object 125 and the associated anchor points 121 may be shared with the second user as described above.

In another implementation, the mapping engine 165 may be incorporated into a video conference application. When a first user connects with a second user on a video conference, their respective client devices 110 may begin capturing image data 119 as part of the video conference. The image processing engine 205 may process the collected image data 119 to generate 3D representations including anchor points 121, of the rooms where each user is participating in the video conference. The anchor points 121 and the locations associated with the video conferences may then be added to the map data 175 and/or the map 179. At a later time, or during the video conference, the first user may place a virtual object 125 in the room used by the second user based on the anchor points 121 of the room, and the second user may use an AR or VR application to view the virtual object 125, or may view the virtual object 125 in the video conference application.

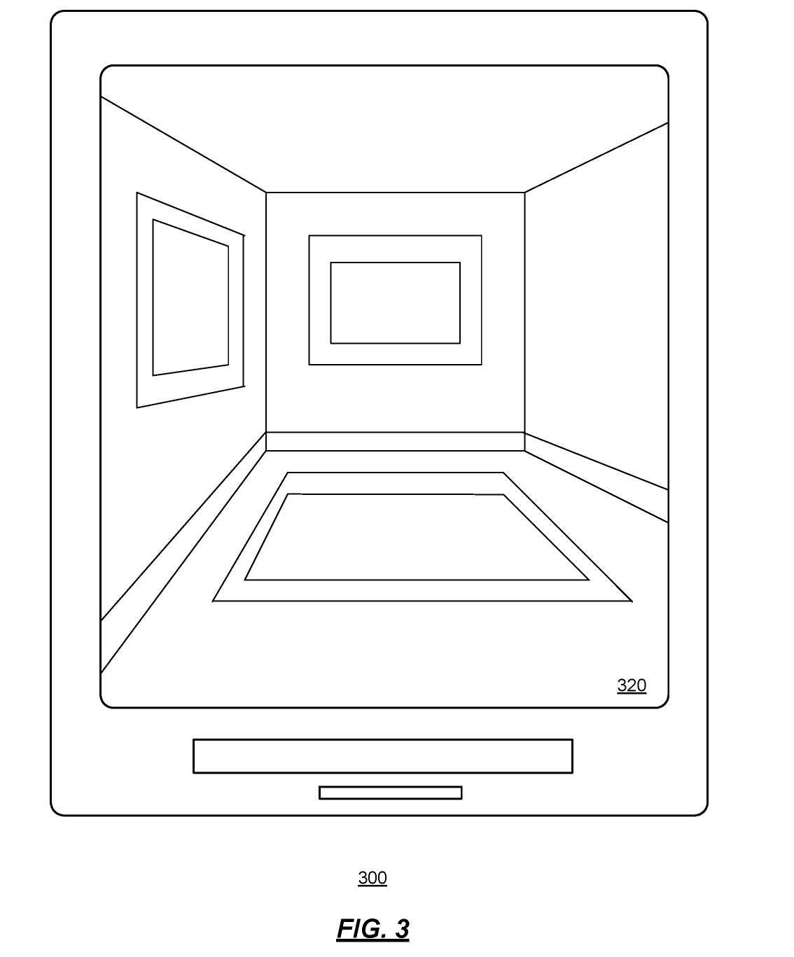

FIG. 3 is an illustration of an example user interface 300 for placing and viewing virtual objects in an AR application. The user interface 300 may be implemented by the client device 110 associated with the user. As shown, the user interface 300 is displayed on a tablet computing device. However, the user interface 300 may also be displayed by other computing devices such as smartphones and videogame devices.

As shown in the window 320, a user is viewing a room using an AR application executing on their client device 110. The user has pointed a camera (not shown) on the rear of the client device 110 at the room. In response, the client device 110 has captured location data 117 and image data 119 about the room, and has provided the captured location data 117 and image data 119 to the mapping engine 165. The client device 110 has further rendered an environment in the window 320 using the image data 119.

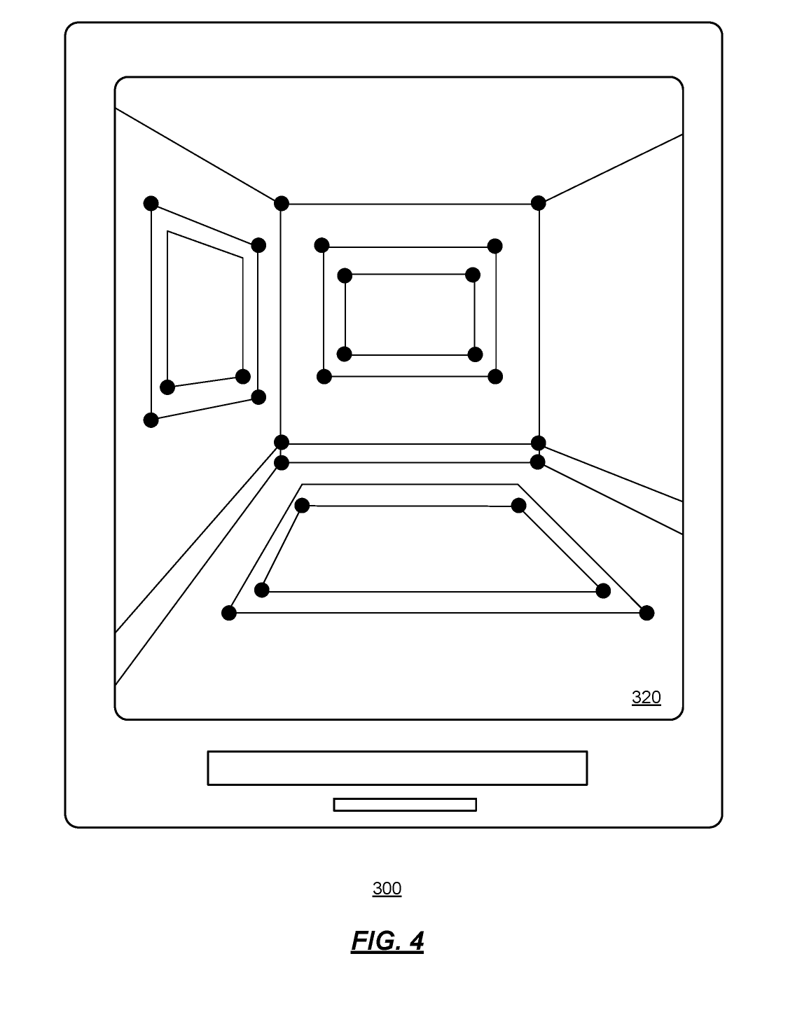

Continuing to FIG. 4, the mapping engine 165 has processed the captured image data 119 and has determined anchor points 121 from the captured image data 119. These anchor points 121 are illustrated in the window 320 as black circles. Depending on the implementation, the determined anchor points 121 may or may not be displayed to the user by the client device 110.

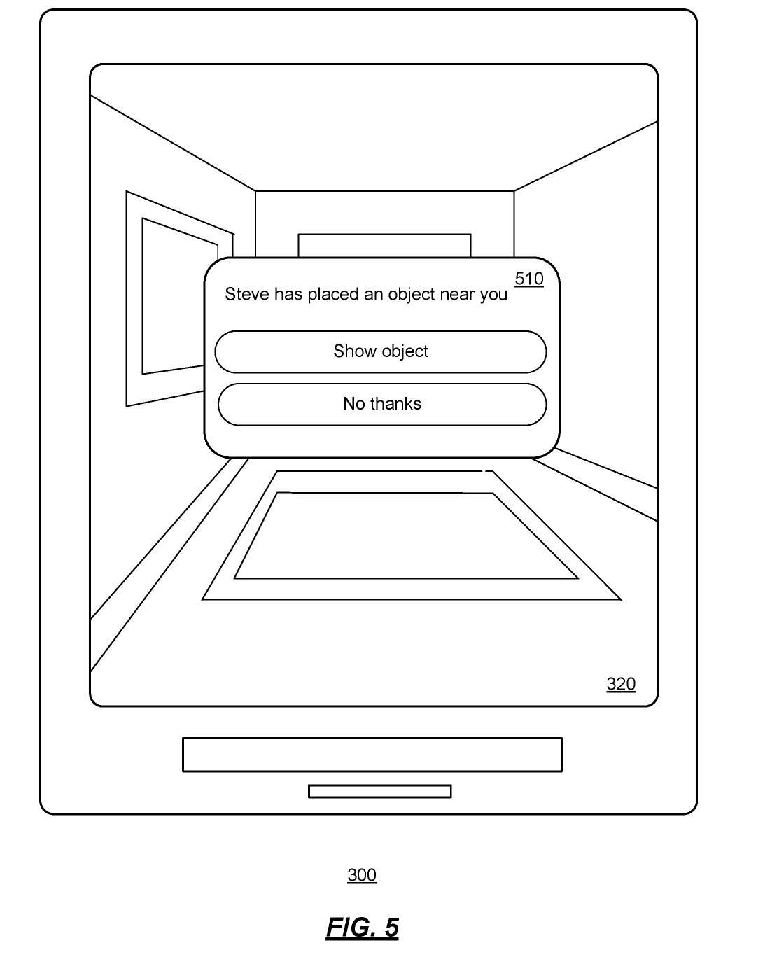

Continuing to FIG. 5, based on the anchor points 121 and the location data 117, the mapping engine 165 has determined a virtual object 125 that is associated with some of the anchor points 121 that were determined by the mapping engine 165 and displayed in FIG. 3. Accordingly, the client device 110 has prompted the user by displaying a window 510 that includes the text “Steve has placed an object near you”. The user can choose to view the virtual object 125 by selecting a user interface element labeled “Show object”, or the user can choose not to view the virtual object 125 by selecting a user interface element labeled “No thanks.”

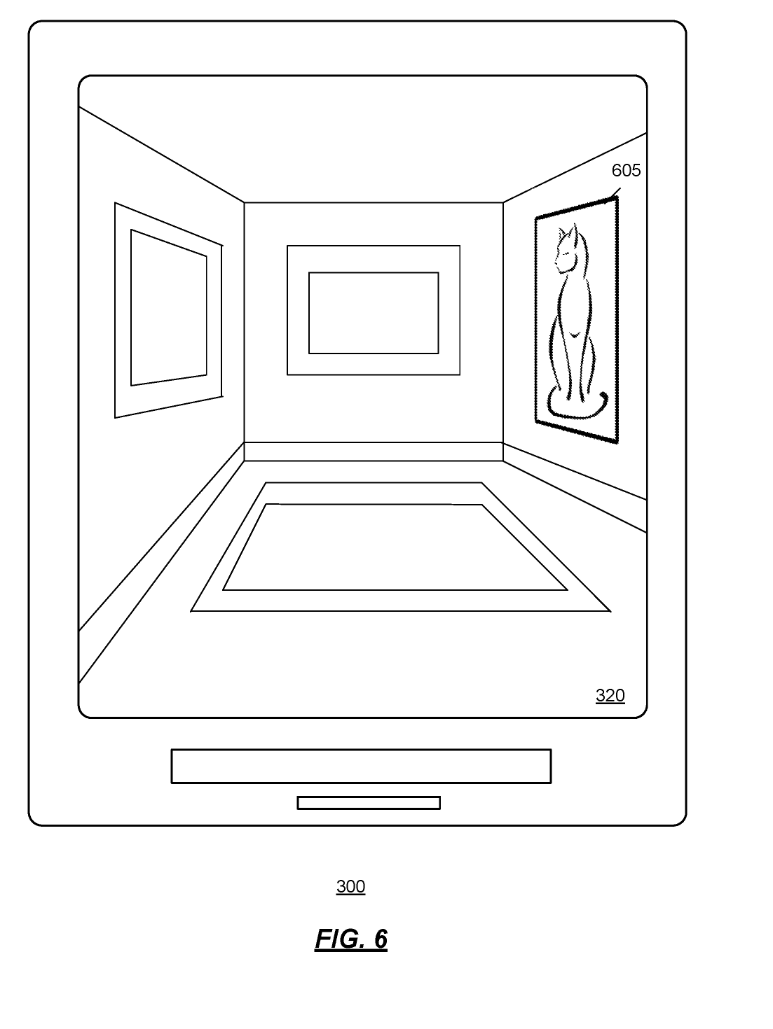

Continuing to FIG. 6, the user has selected the user interface element labeled “Show object”. Accordingly, the virtual object 125 was provided by the mapping engine 165 and is displayed by the client device 110 in the window 320 as the painting 605. Depending on the implementation, the client device 110 may have displayed the painting 605 by matching the anchor points 121 associated with the painting 605 with anchor points 121 determined for the room from the image data 119.

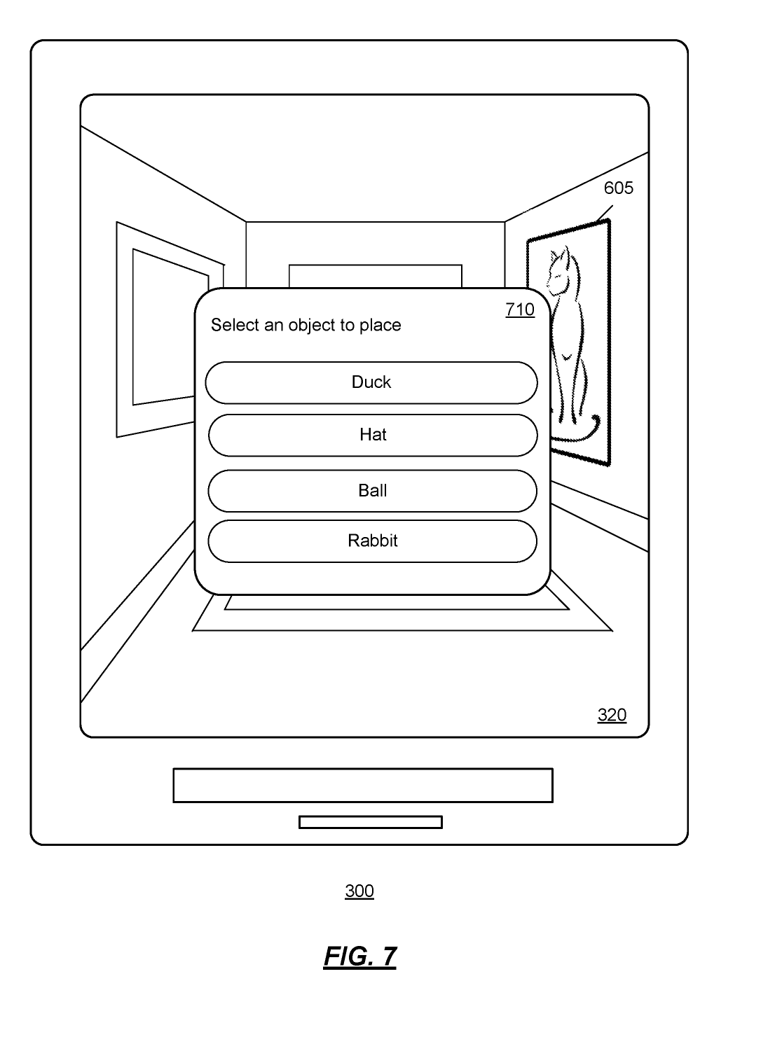

Continuing to FIG. 7, the user has determined to place a virtual object 125 in the room shown in the window 320. Accordingly, a window 710 containing the text “Select an object to place” is displayed in the window 320. The window 710 includes user interface elements that each correspond to a different type of virtual object 125. In the example shown, the user can select from virtual objects 125 that include a “Duck”, a “Hat”, a “Ball”, and a “Rabbit”. Other types of virtual objects 125 may be supported.

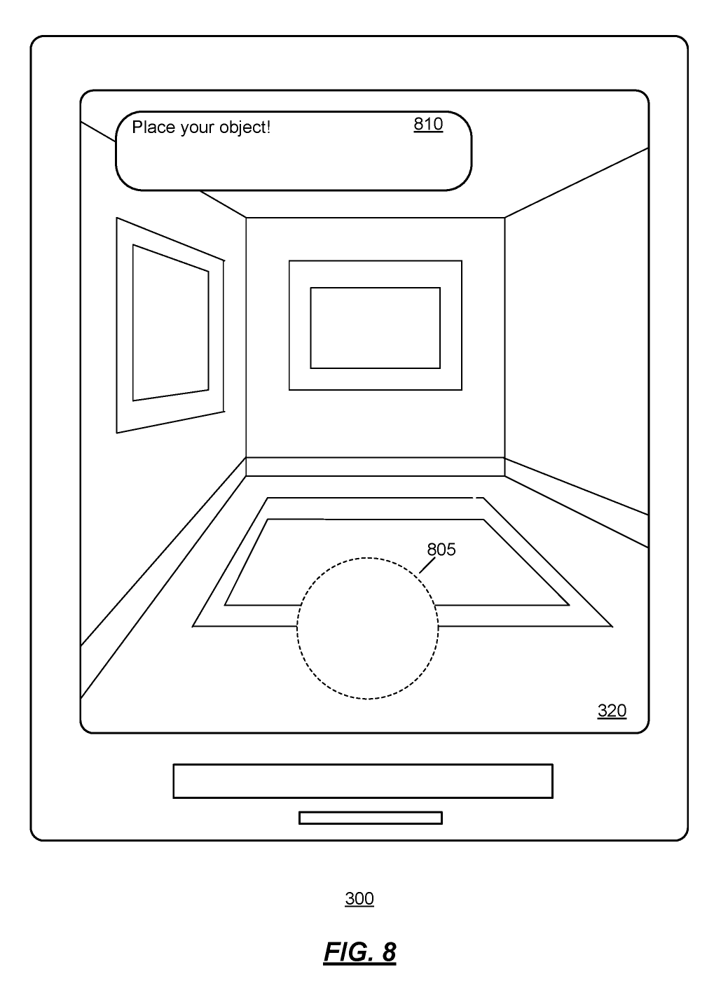

Continuing to FIG. 8, the user has selected to place a “Ball” virtual object 125 in the environment represented in the window 320. The ball virtual object 125 is shown using dotted lines as the object 805. The object 805 may be shown using the dotted lines until the user determines a placement for the object 805 in the environment. The window 320 also includes a window 810 that instructs the user to “Place your object!”.

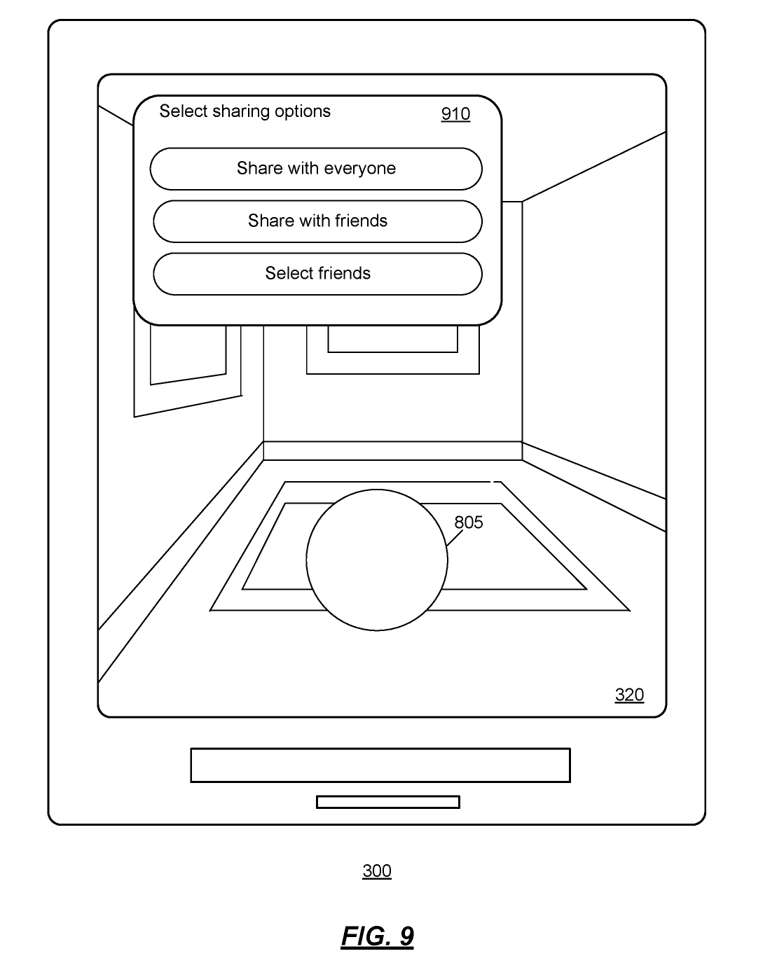

Continuing to FIG. 9, the user has placed the object 805 in the window 320, and the object 805 is now displayed using solid lines to indicate to the user the object 805 has been placed. In response, the mapping engine 165 may have determined one or more anchor points 121 that correspond to the placement of the object 805 in the window 320. The object 805 and the determined anchor points 121 may be associated with the location of the client device 110 and may be stored by the mapping engine 165 with the object data 177.

Also shown in the window 320 is a window 910 that includes various options for the user regarding who the user wants to share the object 805 with. The window 910 includes the text “Select sharing options” and includes user interface elements corresponding to each of the sharing options that are available to the user. The user may select the user interface element labeled “Share with everyone” to share the object 805 with all users of the mapping engine 165. The user may select the user interface element labeled “Share with friends” to share the object 805 with users of the mapping engine 165 that are also friends with the user in one or more social networking applications. The user may select the user interface element labeled “Select friends” to let the user select the particular friends that the object 805 is shared with.

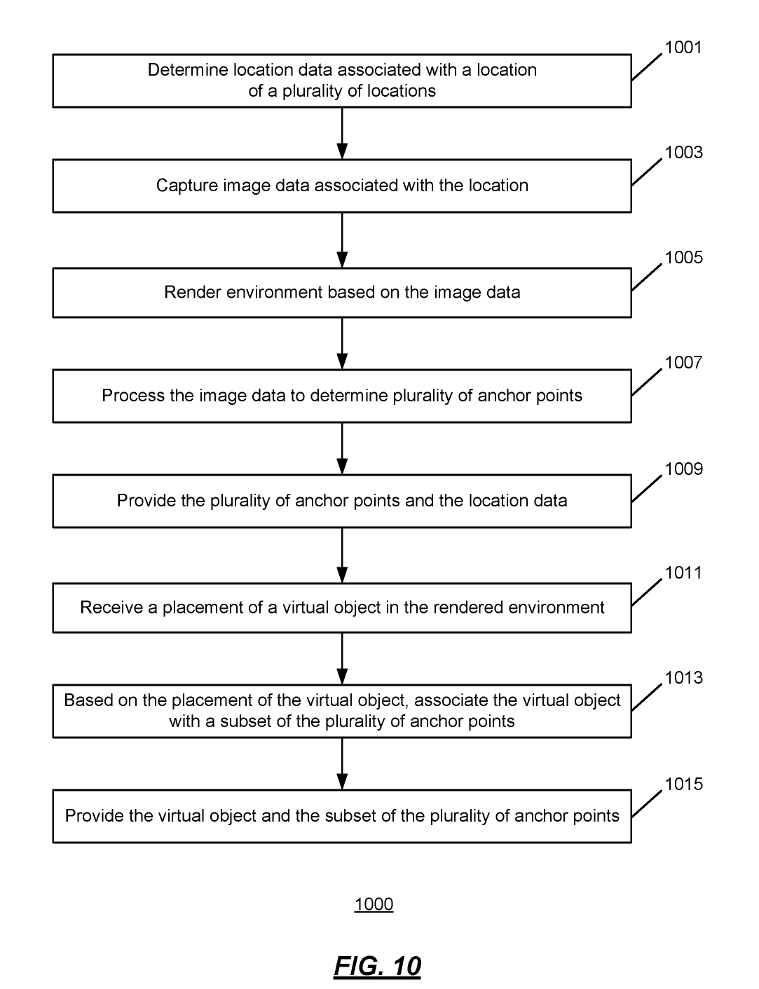

FIG. 10 is an operational flow of an implementation of a method 1000 for collecting image data, determining anchor points in the collected image data, and for associating a virtual object with a subset of the determined anchor points. The method 1000 may be implemented by the mapping engine 165 and/or the client device 110.

At 1001, location data associated with a location of a plurality of locations is determined. The location data 117 may be determined by the client device 110 and/or the location engine 203. The location may be a current location of a client device 110 associated with a user. The plurality of locations may be locations on a map 179. The location data 117 may include one or more of GPS coordinates, altitude measurements, elevation measurements, and orientation measurements. The location data 117 may further include information received from a beacon.

At 1003, image data associated with the location is captured. The image data 119 may be captured by one or more cameras associated with the client device 110. The captured image data 119 may include one or more images or videos.

At 1005, an environment is rendered based on the captured image data. The environment may be rendered by the client device 110 and/or the image processing engine 205. The rendered environment may be displayed to the user on a display associated with the client device 110. Where the client device 110 is a headset, the environment may be formed by the light passing through the lenses of the headset.

At 1007, the image data is processed to determine a plurality of anchor points. The plurality of anchor points 121 may be determined by the client device 110 and/or the image processing engine 205. The plurality of anchor points 121 may correspond to areas of interest in the image data 119 such as corners, walls, floors, objects, etc. Any method or technique for performing 3D reconstruction based on image data may be used.

At 1009, the plurality of anchor points and the location data are provided. The plurality of anchor points 121 and the location data 117 may be provided by the client device 110 to the mapping engine 165. The mapping engine 165 may add the anchor points 121 to a map 179 based on the location data 117. Depending on the implementation, the captured image data 119 may also be provided to the mapping engine 165 and added to the map 179.

At 1011, a placement of a virtual object in the rendered environment is received. The placement of the virtual object 125 may be received by the client device 110 and/or the virtual object engine 210. For example, a user of the client device 110 may select a virtual object 125 from a list of virtual objects 125, and may place the selected virtual object 125 into the environment displayed by their client device 110.

At 1013, based on the placement of the virtual object, the virtual object is associated with a subset of the plurality of anchor points. The virtual object 125 may be associated with the subset of the plurality of anchor points 121 by the client device 110 and/or the virtual object engine 210. Depending on the implementation, the subset of the plurality of anchor points 121 may be determined by determining the anchor points 121 of the plurality of anchor points 121 that are close to the virtual object 121 in the environment. The determined closest anchor points 121 may be selected for the subset of the plurality of anchor points 121 and associated with the virtual object 125.

At 1015, the virtual object and the subset of the plurality of anchor points are provided. The subset of the plurality of anchor points 121 may be provided by the client device 110 to the virtual object engine 210. Depending on the implementation, the virtual object engine 210 may store the virtual object 125 and the subset of anchor points 121 in the object data 177. In addition, the virtual object engine 210 may associate the virtual object 125 with the current location of the client device 110.

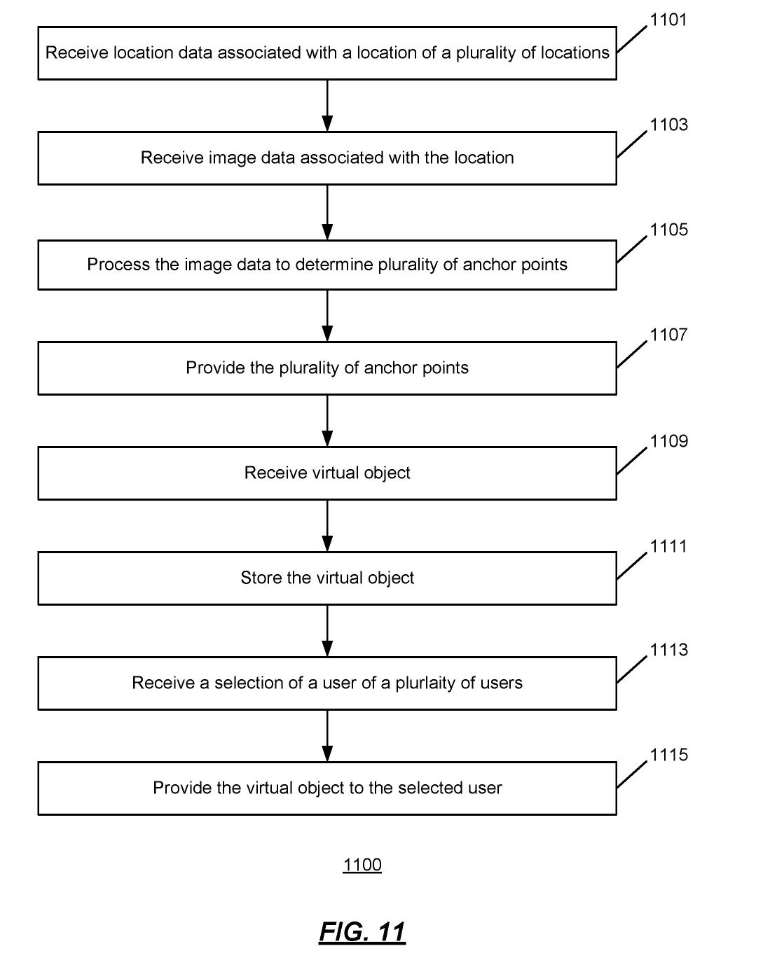

FIG. 11 is an operational flow of an implementation of a method 1100 for receiving image data, determining anchor points in the received image data, receiving a virtual object, and for providing the virtual object to a selected user. The method 1100 may be implemented by the mapping engine 165 and/or the client device 110.

At 1101, location data associated with a location of a plurality of locations is received. The location data 117 may be received by the location engine 203 from the client device 110. The location may be a current location of a client device 110 associated with a user. The plurality of locations may be locations on a map 179.

At 1103, image data associated with a location is received. The image data 119 may be received by the image processing engine 205 from the client device 110. The image data 119 may have been captured by one or more cameras associated with the client device 110.

At 1105, the image data is processed to determine a plurality of anchor points. The plurality of anchor points 121 may be determined by the image processing engine 205. Any method or technique for performing 3D reconstruction based on image data may be used.

At 1107, the plurality of anchor points is provided. The plurality of anchor points 121 may be provided to the client device 110 by the image processing engine 205.

At 1109, a virtual object is received. The virtual object 125 may be received by the virtual object engine 210 from the client device 110. The virtual object 125 may be associated with a subset of anchor points 121 of the plurality of anchor points 121. The virtual object 125 may also be associated with one or more user permissions 226, one or more display options 227, and one or more geofences 228. Depending on the implementation, the received virtual object 125 may have been placed in an environment rendered or displayed by the client device 110. The client device 110 may have determined the subset of anchor points 121 based on the placement.

At 1111, the virtual object is stored. The virtual object 125 may be stored in the object data 177 by the virtual object engine 210 along with the subset of the plurality of anchor points 121.

At 1113, a selection of a user of plurality of users is received. The selection of a user may be received by the presentation engine 215 from the client device 110. Depending on the implementation, the user that provided the virtual object 125 may have selected a user to receive the virtual object 125.

At 1115, the virtual object is provided to the selected user. The virtual object 125 may be provided to the selected user by the presentation engine 215. The virtual object 125 may be provided to a client device 110 associated with the selected user. An AR application associated with the selected user may then render and display the virtual object 125 when the client device 110 associated with the selected user is at or near the location of the plurality of locations.

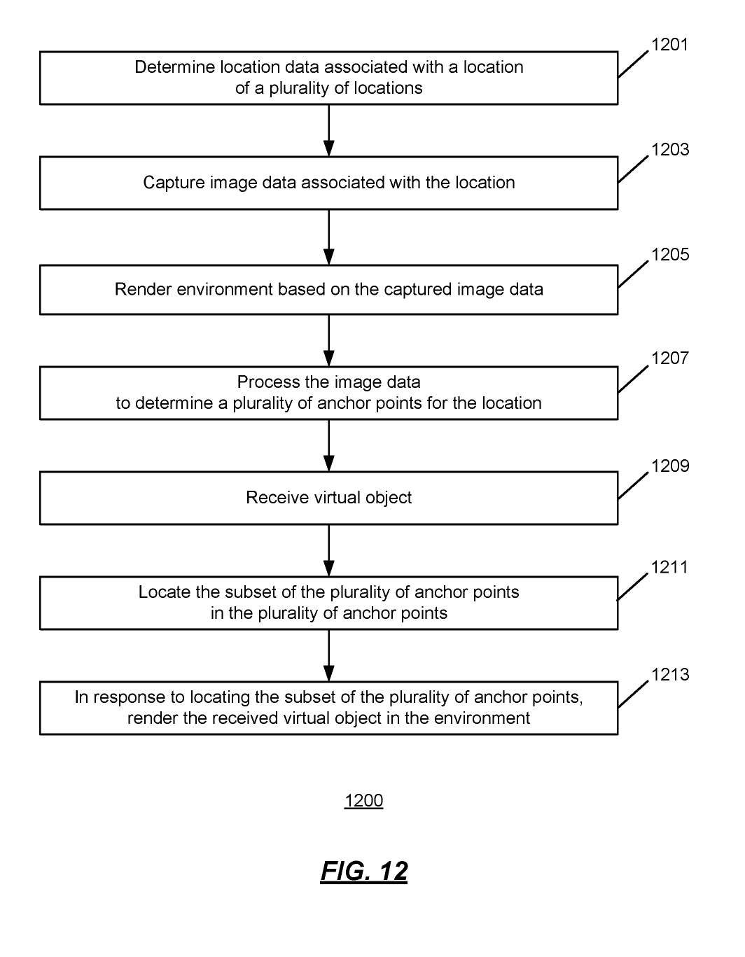

FIG. 12 is an operational flow of an implementation of a method 1200 for capturing image data for a location, rendering an environment based on the captured image data, receiving a virtual object, and rendering the received virtual object in the environment. The method 1200 may be implemented by the mapping engine 165 and/or the client device 110.

At 1201, location data associated with a location of a plurality of locations is determined. The location data 117 may be determined by the client device 110 and/or the location engine 203. The location may be a current location of a client device 110 associated with a user. The plurality of locations may be locations on a map 179. The location data 117 may include one or more of GPS coordinates, altitude measurements, elevation measurements, and orientation measurements. The location data 117 may further include information received from a beacon.

At 1203, image data associated with a location is captured. The image data 119 may be captured by one or more cameras associated with the client device 110. The captured image data 119 may include one or more images or videos.

At 1205, an environment is rendered based on the captured image data. The environment may be rendered by the client device 110 and/or the image processing engine 205. The rendered environment may be displayed to the user on a display associated with the client device 110, for example. Any method or technique for performing 3D reconstruction based on image data may be used.

At 1207, the image data is processed to determine a plurality of anchor points for the location. The plurality of anchor points 121 may be determined by the image processing engine 205 and/or the client device 110.

At 1209, a virtual object is received. The virtual object 125 may be received by the client device 110 and/or the virtual object engine 210. The received virtual object 125 may be associated with the location of the plurality of locations, and may be associated with a subset of the plurality of anchor points 121.

At 1211, the subset of the plurality of anchor points is located in the plurality of anchor points. The subset of the plurality of anchor points 121 may be located in the plurality of anchor points 121 by the virtual object engine 210 and/or the client device 110.

At 1213, the received virtual object is rendered in the environment at the subset of the plurality of anchor points. The virtual object 125 may be rendered by the presentation engine 215 and/or the client device 110 in response to locating the subset of the plurality of anchor points 121.

FIG. 13 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 13, an exemplary system for implementing aspects described herein includes a computing device, such as computing device 1300. In its most basic configuration, computing device 1300 typically includes at least one processing unit 1302 and memory 1304. Depending on the exact configuration and type of computing device, memory 1304 may be volatile (such as random access memory (RAM)), non-volatile (such as read-only memory (ROM), flash memory, etc.), or some combination of the two. This most basic configuration is illustrated in FIG. 13 by dashed line 1306.

Computing device 1300 may have additional features/functionality. For example, computing device 1300 may include additional storage (removable and/or non-removable) including, but not limited to, magnetic or optical disks or tape. Such additional storage is illustrated in FIG. 13 by removable storage 1308 and non-removable storage 1310.

Computing device 1300 typically includes a variety of computer readable media. Computer readable media can be any available media that can be accessed by the device 1300 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1304, removable storage 1308, and non-removable storage 1310 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1300. Any such computer storage media may be part of computing device 1300.

Computing device 1300 may contain communication connection(s) 1312 that allow the device to communicate with other devices. Computing device 1300 may also have input device(s) 1314 such as a keyboard, mouse, pen, voice input device, touch input device, etc. Output device(s) 1316 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for capturing image data for locations, determining anchor points in the captured image data for the locations, and for sharing the determined anchor points and captured image data for use in augmented reality and virtual reality applications is provided. The system includes: at least one computing device; and a mapping engine that: determines location data associated with a location of a plurality of locations; captures image data associated with the location; renders an environment based on the captured image data; processes the captured image data to determine a plurality of anchor points for the location; and provides the plurality of anchor points and the location data for the location.

Implementations may include some or all of the following features. The image data may include one or more images or videos. The location data may include one or more of GPS coordinates, altitude measurements, elevation measurements, and orientation measurements. The location data may include data received from a beacon. The mapping engine further: receives a placement of a virtual object in the rendered environment; based on the placement of the virtual object in the rendered environment, associates the virtual object with a subset of anchor points of the plurality of anchor points; and provides the virtual object and the associated subset of anchor points. The virtual object may be associated with one or more geofences. The virtual object may be associated with one or more user permissions. The mapping engine further: receives a virtual object associated with the location, wherein the virtual object is associated with a subset of anchor points of the plurality of anchor points; and renders the received virtual object in the environment based on the subset of anchor points associated with the virtual object.

In an implementation, a method for receiving image data for locations, determining anchor points in the received image data for the locations, receiving virtual objects associated with the locations, and storing the received virtual objects for use in augmented reality and virtual reality applications is provided. The method may include: receiving location data associated with a location of a plurality of locations by a computing device; receiving image data associated with the location by the computing device; processing the image data to determine a plurality of anchor points for the location by the computing device; providing the plurality of anchor points by the computing device; receiving a virtual object by the computing device, wherein the virtual object is associated with a subset of the plurality of anchor points; and storing the virtual object and the plurality of anchor points with the location data by the computing device.

Implementations may include some or all of the following features. The method may further include: receiving a selection of a user of a plurality of users; and providing the virtual object to the selected user. The method may further include: receiving the location data again after storing the virtual object and the plurality of anchor points; and in response to the receiving the location again, providing the stored virtual object and the subset of the plurality of anchor points. The virtual object may be further associated with one or more geofences. The image data may include one or more images or videos.

In an implementation, a system for capturing image data for locations, rendering environments based on the captured image data, and for rendering received virtual objects in the rendered environments for use in augmented reality and virtual reality applications is provided. The system includes at least one computing device; and a mapping engine that: determines location data associated with a location of a plurality of locations; captures image data associated with the location; renders an environment based on the captured image data; processes the captured image data to determine a plurality of anchor points for the location; receives a first virtual object associated with a first subset of the plurality of anchor points; locates the first subset of the plurality of anchor points in the plurality of anchor points; and in response to locating the first subset of the plurality of anchor points, renders the received first virtual object in the rendered environment based on the first subset of the plurality of anchor points.

Implementations may include some or all of the following features. The mapping engine further: receives a placement of a second virtual object in the rendered environment; based on the placement of the second virtual object in the rendered environment, associates the second virtual object with a second subset of the plurality of anchor points; and provides the second virtual object. The mapping engine further: receives a selection of a user of a plurality of users; and provides the second virtual object to the selected user. The image data may include one or more of images or videos. The location data may include one or more of GPS coordinates, altitude measurements, elevation measurements, and orientation measurements. The location data may include data received from a beacon. The first virtual object may be further associated with one or more geofences.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for capturing image data for locations, determining anchor points in the captured image data for the locations, and for sharing the determined anchor points and captured image data for use in augmented reality and virtual reality applications, the system comprising:
at least one computing device; and
a mapping engine that:
determines location data associated with a location of a plurality of locations;
captures image data associated with the location;
renders an environment based on the captured image data;
processes the captured image data to determine a plurality of anchor points for the location; and
provides the plurality of anchor points and the location data for the location.

2. The system of claim 1, wherein the image data comprises one or more images or videos.

3. The system of claim 1, wherein the location data comprises one or more of GPS coordinates, altitude measurements, elevation measurements, and orientation measurements.

4. The system of claim 1, wherein the location data further comprises data received from a beacon.

5. The system of claim 1, wherein the mapping engine further:
receives a placement of a virtual object in the rendered environment;
based on the placement of the virtual object in the rendered environment, associates the virtual object with a subset of anchor points of the plurality of anchor points; and
provides the virtual object and the associated subset of anchor points.

6. The system of claim 5, wherein the virtual object is associated with one or more geofences.

7. The system of claim 5, wherein the virtual object is associated with one or more user permissions.

8. The system of claim 1, wherein the mapping engine further:
receives a virtual object associated with the location, wherein the virtual object is associated with a subset of anchor points of the plurality of anchor points; and
renders the received virtual object in the environment based on the subset of anchor points associated with the virtual object.

9. A method for receiving image data for locations, determining anchor points in the received image data for the locations, receiving virtual objects associated with the locations, and storing the received virtual objects for use in augmented reality and virtual reality applications, the method comprising:
receiving location data associated with a location of a plurality of locations by a computing device;
receiving image data associated with the location by the computing device;
processing the image data to determine a plurality of anchor points for the location by the computing device;
providing the plurality of anchor points by the computing device;
receiving a virtual object by the computing device, wherein the virtual object is associated with a subset of the plurality of anchor points; and
storing the virtual object and the plurality of anchor points with the location data by the computing device.

10. The method of claim 9, further comprising:
receiving a selection of a user of a plurality of users; and
providing the virtual object to the selected user.

11. The method claim 9, further comprising:
receiving the location data again after storing the virtual object and the plurality of anchor points; and
in response to the receiving the location again, providing the stored virtual object and the subset of the plurality of anchor points.

12. The method of claim 9, wherein the virtual object is associated with one or more geofences.

13. The method of claim 9, wherein the image data comprises one or more images or videos.

14. A system for capturing image data for locations, rendering environments based on the captured image data, and for rendering received virtual objects in the rendered environments for use in augmented reality and virtual reality applications, the system comprising:
at least one computing device; and
a mapping engine that:
determines location data associated with a location of a plurality of locations;
captures image data associated with the location;
renders an environment based on the captured image data;
processes the captured image data to determine a plurality of anchor points for the location;
receives a first virtual object associated with a first subset of the plurality of anchor points;
locates the first subset of the plurality of anchor points in the plurality of anchor points; and
in response to locating the first subset of the plurality of anchor points, renders the received first virtual object in the rendered environment based on the first subset of the plurality of anchor points.

15. The system of claim 14, wherein the mapping engine further:
receives a placement of a second virtual object in the rendered environment;
based on the placement of the second virtual object in the rendered environment, associates the second virtual object with a second subset of the plurality of anchor points; and
provides the second virtual object.

16. The system of claim 15, wherein the mapping engine further:
receives a selection of a user of a plurality of users; and
provides the second virtual object to the selected user.

17. The system of claim 14, wherein the image data comprises one or more of images or videos.

18. The system of 14, wherein the location data further comprises one or more of GPS coordinates, altitude measurements, elevation measurements, and orientation measurements.

19. The system of claim 14, wherein the location data comprises data received from a beacon.

20. The system of claim 14, wherein the first virtual object is further associated with one or more geofences.
